(19) United States
(12) Patent Application Publication
(10) Pub. No.: US 2005/0223789 A1
(43) Pub. Date: Oct. 13, 2005

(54) Composition and method for measuring oil and grease repellency of paper and paperboard

(76) Inventor: Yue Liu, Ridgewood, NJ (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/504,993

(22) PCT Filed: Feb. 13, 2003
(86) PCT No.: PCT/EP03/01427

§ 371 Date: Mar. 28, 2005

Related U.S. Application Data
(60) Provisional application No. 60/358,999, filed on Feb. 21, 2002.

(51) Int. Cl. G01B 21/08

(52) U.S. Cl. 73/150 R

(57) ABSTRACT

A composition comprising an unsaturated oil such as corn oil, vegetable oil or sesame oil, a liquid hydrocarbon such as heptane, a C₁-C₄alkoxy-C₁-C₄alkanol such as 2-ethoxyethanol and an oil-soluble dye is employed for accurate, rapid, and highly reproducible determinations of the treatment level and performance of fluorochemically treated grease-repellent paper, which is used for example in food service.

### BACKGROUND OF THE INVENTION

1. Field of the Invention

The invention relates to compositions and methods for testing the oil and grease repellency of fluorochemically treated paper or paperboard.

2. Brief Description of the Prior Art

A multitude of methods for testing paper and paperboard for resistance to wetting and penetration by oils and grease exist. Many of them have been established for glassine and parchment grades of paper, and for packaging films. These tests, in general, are not applicable to fluorochemically treated grease-repellent paper and Paperboard, which have a much higher porosity.

Two types of tests are generally performed on fluorochemically treated grease-repellent paper and paperboard. These are the end use (performance) tests and quality control tests.

End use tests refer to measuring the ability of paper or paperboard to perform its desired functions (pet food package protection, fast food service containing, etc.). End use testing is used to determine the most suitable fluorochemical, treatment level and application method in the paper mill. This information is then, ideally, correlated to a rapid quality control test. Because of the wide variety of materials that can be effectively protected against by fluorochemically treated paper, grease-repellent paper manufacturers practice many specific end use tests.

The Ralston Purina Company uses its RP-2 Test as its pet food packaging end use test (Ralston-Purina Company, Packaging Reference Manual Volume 06—Test Methods). This test determines the amount of oil penetration through a sample of grease-repellent paper under controlled conditions of time and temperature. In the RP-2 test, a 4 inch by 4 inch sample of paper is placed on a grid printed sheet. Next 5 grams of sand is placed on the sample paper; then 1.3 cc of red dyed synthetic oil is then added to the sand pile. After the sample paper is stored at 140° F. (40° C.) for 24 hours, the grid sheet is examined for stains and the percent of stain is reported.

The most widely used quality control test is the oil kit test (TAPPI T 559 pm-96). This test consists of solutions numbered 1-12 that contain specific ratios of three reagents: castor oil, toluene, and heptane. Solution number 1 is the least aggressive, having the highest surface tension, viscosity and contact angle on treated paper, and solution number 12 is the most aggressive, having the lowest surface tension, viscosity and contact angle on the treated paper. The various solutions are dropped onto the substrate from a height of one-half inch. After 15 seconds, the solutions are quickly removed with tissue. The kit rating is defined as the highest numbered solution that does not stain the substrate as judged by the analyst.

The present invention is intended to overcome the drawbacks of the prior art. The drawbacks associated with the above-mentioned RP-2 end use test are subjectivity in estimating the area of stains, the time consumed (24-hours) and poor reproducibility. The drawbacks of the oil kit test are its subjectivity and poor relevance to end use performance.

It is an object of this invention to provide a composition and method which enables the quantitative measurement of grease-repellency of paper and paperboard with reliability, ease of use, objectivity, speed, reproducibility and sensitivity to sizing changes.

### SUMMARY OF THE INVENTION

In one aspect the present invention comprises a composition for testing oil and grease-repellent paper or paperboard accurately, rapidly and reproducibly, which composition comprises an unsaturated oil, a liquid hydrocarbon, a C₁-C₄alkoxy-C₁-C₄alkanol and an oil-soluble dye.

In another aspect the present invention comprises a method of measuring the oil and grease-repellency of paper or paperboard which comprises applying the inventive dye-containing test solution to a sheet of paper or paperboard and measuring with a photoelectric cell the drop in reflectance (brightness) of the opposite side of the sheet as the solution penetrates. When the reflectance drops to a predetermined level, a timer is stopped to indicate the test time. A longer the test time indicates a higher oil and grease repellency.

This composition and test method can be used both as an end use test and a quality control test. The present invention is an improvement over prior art methodology in that it provides accurate, rapid and reproducible determination of treatment level and performance of fluorochemical treated grease-repellent paper or paperboard and, at the same time, eliminates the error due to subjectivity that is part of many existing test methods.

### DETAILED DESCRIPTION OF THE INVENTION

Fluorochemical sizing has been the technology of choice for manufacturing grease-repellent paper and paperboard for more than three decades. During the manufacturing processes as well as in the research and development laboratories, it is important to have a good test methodology that can correlate end use performance with fluorochemical treatment levels. Other requirements of such tests are reliability, ease of use, objectivity, sensitivity to sizing changes, speed and reproducibility.

When a fluorochemical is used to treat paper and paperboard, the contact angle θ that oil or grease forms on treated fibers is decreased compared with that formed on untreated fibers. This reduction is attributed to the reduced surface energy of the treated fibers. For example, the contact angle for vegetable oil on the base stock for pet food packaging grade paper is 20 degrees. After fluorochemical treatment, it is in the range of 70 to 100 degrees depending on the treatment levels. Assuming a value of 100 at a contact angle of 20 degrees, the rate of penetration of vegetable oil into paper would be 36 and 18 for contact angles of 70 and 100 degrees, respectively, according to Washburn equation (see below).

While the effect of fluorochemical sizing can be described by using only one factor, i.e., the contact angle of oil on paper or paperboard, two independent variables associated with the penetrating liquid could be conveniently used to describe the principles involving testing of the paper and paperboard. These are the surface tension and viscosity of the test liquid.

It is useful to consider the overall process of test liquid penetrating paper as consisting of two stages, and to take each stage separately in order to assess the importance of the various factors involved. These two stages are quite distinct in their nature, but in practice they overlap. The principles involved in each stage are fairly well established but because of the overlap it is often not easy to recognize any particular aspect In a practical test. The two stages to be considered are the following:

(a) Wetting

Wetting describes the process that occurs when paper or paperboard and a test liquid come into contact so that the fiber-air interface is replaced by the fiber-liquid interface. For simplicity, we will only consider spreading wetting. When a drop of testing liquid spreads over the surface of a paper or paperboard, for the unit area of fiber surface that disappears an equivalent area of liquid surface and fiber-liquid interface are formed. The work involved is
ΔG=γ_{fl}+γₗ−γ_{f},
where γ_{fl} is the fiber-liquid interfacial energy, γ_{f} the surface energy of fiber and γₗ is the surface tension of the testing liquid. The values of γ_{fl} and γ_{f} are not easily obtained, but they are related by the Young's equation through the contact angle,
γ_{f}=γ_{fl}+γₗ cos θ.

This provides a means of evaluating the wetting functions in terms of the measurable quantities γₗ and θ, where θ is the contact angle between the testing liquid and the fibers. Using the Young's equation, the free energy change can be written as
ΔG=γ_{fl}+γₗ−γ_{f}=−γₗ(cos θ−1).

As usual with free energies, a negative value for ΔG means that the spreading wetting process occurs spontaneously. In fact, the negative of ΔG is called the spreading coefficient. Because of the sign change, a positive spreading coefficient predicts the testing liquid spreads freely over the paper or paperboard surface and wets it. Spreading wetting will happen spontaneously only when θ equals zero. The dominating factor in wetting is the surface tension of the testing liquid γₗ. The lower the surface tension of the testing liquid, the more aggressive it is.

(b) Penetration

Penetration is not involved with all test procedures for grease and oil resistance. It usually is involved when the substrate is porous, such as paper and paperboard. The rate of penetration of a test liquid into a porous substrate is commonly assumed to obey the Washburn equation,

$$\frac{ⅆ l}{ⅆ t} = \frac{R γ cos θ}{4 η l} ,$$

where I is the distance of liquid penetration, R is the capillary radius, γ is the liquid surface tension, η is the test liquid's viscosity, and θ is the contact angle the liquid forms on the fiber surface. Among these parameters, γ and η are the properties of the test liquid. To achieve rapid penetration (aggressive test conditions), high γ cos θ, low η and low η are desirable. High γ and low θ are normally incompatible; a low θ is more important, but when η=0 further lowering of γ will reduce the rate of penetration. The desired degree of aggressiveness of the test liquid can be achieved by carefully choosing its composition.

As previously mentioned, one aspect of the invention comprises a composition for testing oil and grease-repellent paper or paperboard, which has been treated with a fluorochemical sizing agent, accurately, rapidly and reproducibly, which composition comprises an unsaturated oil, a liquid hydrocarbon, a C₁-C₄alkoxy-C₁-C₄alkanol and an oil-soluble dye.

Suitable unsaturated oils include, but are not limited to corn oil, vegetable oil or sesame oil.

The liquid hydrocarbon may be linear, branched or cyclic or a mixture thereof. It is preferably a C₆-C₁₀alkane. Suitable liquid hydrocarbons include, but are not limited to linear or branched hexanes, heptanes, octanes, nonanes and decanes; cyclohexane, cycloheptane, methylcycloheptane, cyclooctane and various commercially available distillates containing predominantly C₆-C₁₀alkanes. In one embodiment the liquid hydrocarbon is n-heptane.

By an oil-soluble dye is meant one that is soluble in the mixture of the other components at the intended use concentrations. Such oil-soluble dyes include, but are not limited to those classified as SOLVENT DYES in the Colour Index (C.I.).

The oil-soluble dye preferably has an absorption maximum at about 700 nm, such as the C.I. SOLVENT GREEN dyes. In one embodiment the oil-soluble dye is C.I. SOLVENT GREEN 3 dye (C.I. Number 61565), which is available from C. Lever Company, 736 Dunksferry Road, Bensalem, Pa. 19020 as Green NG powder.

The C₁-C₄alkoxy-C₁-C₄alkanol is for example 2-methoxyethanol, 2-ethoxyethanol, 2-propoxyethanol, 2-butoxyethanol 2-methoxypropanol or 2-ethoxypropanol, especially 2-ethoxyethanol.

One embodiment of the invention comprises a composition which comprises from 20 to 50% by weight of an unsaturated oil, from 30 to 70% by weight of a liquid hydrocarbon, from 5 to 35% by weight of a C₁-C₄alkoxy-C₁-C₄alkanol and from 0.01 to 0.05% by weight of an oil-soluble dye, based on the total weight of the composition.

A preferred embodiment of the invention comprises from 25 to 50% by weight of a component selected from the group consisting of corn oil, vegetable oil and sesame oil, from 30 to 60% by weight of heptane, from 10 to 30% by weight of 2-ethoxyethanol and from 0.01 to 0.03% by weight of C.I. SOLVENT GREEN 3 dye, based on the total weight of the composition.

The composition of the test solution for a rapid measurement of oil and grease repellency of paper and paperboard is designed to have a relatively high degree of aggressiveness, both with respect to wetting and penetration, as defined by the spreading coefficient and the Washburn equation. The dye component enables an accurate photometric determination of the degree of penetration of the test solution.

The major components are characterized, respectively, by their Brookfield viscosities (LV-1 spindle, 60 rpm), surface tensions and the contact angles they form on a Teflon surface as shown in Table 1:

TABLE 1

| | Viscosity | Surface Tension | Contact Angle |
|---|---|---|---|
| | (cP) | (dynes/cm²) | (Degrees) |
| Corn Oil | 53.5 | 33.5 | 58 |
| Vegetable Oil | 44.4 | 33.3 | 58 |
| Sesame Oil | 56.5 | 32.9 | 58 |
| heptane | 0.42 | 20.1 | 10 |
| 2-ethoxyethanol | 2.05 | 28.8 | 47 |

One illustrative embodiment of the composition for measuring oil and grease repellency of fluorochemically treated paper and paperboard can be prepared by combining the components as listed in Table 2 and mixing:

TABLE 2

| Reagent | Weight (g) |
|---|---|
| Corn Oil | 37 |
| Heptane | 43 |
| 2-Ethoxyethanol | 20 |
| Green NG Powder | 0.02 |

When preparing the testing solutions, one should avoid measuring the reagents volumetrically since there will be a loss of volume upon mixing. The test solution is storage-stable in a sealed bottle.

Method of Measurement

The test solution system is preferably used with a single purpose photometer. The dye-containing test solution is placed on a sample of paper or paperboard and a photoelectric cell registers the drop in reflectance (brightness) of the opposite side of the sheet as the solution penetrates. When the reflectance drops to a predetermined level, a timer is stopped to indicate the test time. A longer test time indicates a higher degree of oil and grease repellency.

Thus another aspect of the present invention comprises a method of measuring the oil and grease-repellency of paper or paperboard, which comprises applying the inventive dye-containing test solution comprising an unsaturated oil, a liquid hydrocarbon, a C₁-C₄alkoxy-C₁-C₄alkanol and an oil soluble dye to a sheet of paper or paperboard and measuring with a photoelectric cell the change in reflectance of the opposite side of the sheet as a function of time. In a first preferred method, the composition comprises from 20 to 50% by weight of an unsaturated oil, from 30 to 70% by weight of a liquid hydrocarbon, from 5 to 35% by weight of a C₁-C₄alkoxy-C₁-C₄alkanol and from 0.01 to 0.05% by weight of an oil soluble dye, preferably having an absorption maximum at about 700 nm, based on the total weight of the composition. In a more preferred method, the dye-containing test solution comprises from 25 to 50% by weight of a component selected from the group consisting of corn oil, vegetable oil and sesame oil, from 30 to 60% by weight of heptane, from 10 to 30% by weight of 2-ethoxyethanol, from 0.01 to 0.03% by weight of C.I. SOLVENT GREEN 3 dye, based on the total weight of the composition.

The most convenient realization of the above test procedure is to use a paper sizing tester such as the Hercules™ Sizing Tester, which is a widely used size tester for measuring ink penetration of paper and paperboard and which measures the change in reflectance of the opposite side of the sheet as a function of time and comprises a photoelectric cell. The Hercules™ Sizing Tester is available for purchase from Hercules Incorporated. When the Hercules™ Sizing Tester is employed, the tests using the above solution system are run in the same manner as ink penetration tests.

The following examples describe certain embodiments of this invention, but the invention is not limited thereto. It should be understood that numerous changes to the disclosed embodiments could be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight unless otherwise indicated.

The paper samples used In the following examples were all made on commercial paper machines. The fluorochemical used was Lodyne® P-208E (a perfluoroalkyl-substituted phosphate ester acid, ammonium salt) from Ciba Specialty Chemicals Corporation. The fluorochemical was co-applied with cooked starch solutions to the paper using a size press. This mode of application of fluorochemicals is most commonly used.

### EXAMPLE 1

This example illustrates the correlation between the test time, determined according to the present invention using a Hercules™ Sizing Tester, and the results of the RP-2 end use test, as a function of fluorochemical dosage.

Paper samples are cut into 70×80 mm sizes. The cut samples should be handled by the corners. The region that will be in contact with the test solutions should not be touched.

A paper sample is placed in the sample holder of the tester (the side up will be in contact with the test solution). The holder containing the sample is positioned in a retaining ring on top of the tester. Then 10 ml of the test solution is poured onto the sample and simultaneously the timer is started. When the reflectance drops to a predetermined level, the automatic timer is stopped to indicate the test time.

The results are shown in Table 3.

TABLE 3

| | Fluorochemical | | |
|---|---|---|---|
| | Dosage | RP-2 Test | Test Time |
| Sample | (kg/ton) | (Staining, %) | (sec) |
| A | 6.1 | 6.5 | 20 |
| B | 7.5 | 0.3 | 210 |
| C | 9.2 | 0.1 | 480 |
| D | 9.4 | 0.0 | 590 |

The reflectance in the Hercules™ Sizing Tester was set at 85%. The test time was the average of 5 specimens. The paper test samples (41 pound) were made from bleached kraft pulp. The fluorochemical was added to the starch bath and to the paper at the size press. The average test sensitivity was about 166 seconds/(kg/ton).

FIG. 1 shows the results of the RP-2 test plotted against test time. While the relationship between test time and fluorochemical dosage is relatively linear in the range available for testing, the correlation to the end use test can be viewed as an on/off type if one takes into consideration that a pass rating in the RP-2 test is less than 2% of staining (FIG. 1). For this particular grade, 100-seconds and above is a pass; otherwise it is a fail.

[image]

### EXAMPLE 2

The paper is 39 pound waterleaf treated with the fluorochemical along with starch solution as the carrier. The test results are presented in Table 4:

TABLE 4

| | Fluorochemical | |
|---|---|---|
| | Dosage | Test Time |
| Sample | (kg/ton) | (sec) |
| 1 | 3.9 | 12 |
| 2 | 5.4 | 123 |
| 3 | 7.7 | 322 |
| 4 | 9.3 | 605 |
| 5 | 11.6 | 766 |

Again the test time is the average of 5 specimens to the nearest second for a reflectance of 85%.

These results clearly demonstrate the suitability of the composition and method as both a quality control test and end use test. The test time has a good linear relationship with treatment level and correlates to end use test results such as those of the RP-2 test. For most grades of paper, the test can be done within reasonably short period of time by adjusting the percentage reflectance endpoint if necessary. Good reproducibility is obtained when there is at least a 30 second test time.

When possible, reflectance endpoints in the range of 50 to 85% should be used. Reflectance endpoints of 90% or higher give a low meter deflection, and the results are affected to a great extent by paper variations. Reflectance endpoints below 40% should generally not be used because most papers are almost saturated with the test solution by this point.

1. A composition for measuring the oil and grease repellency of paper or paperboard treated with a fluorochemical sizing agent, which comprises an unsaturated oil, a liquid hydrocarbon, a C₁-C₄alkoxy-C₁-C₄alkanol and an oil-soluble dye.

2. A composition according to claim 1, wherein the unsaturated oil is corn oil, vegetable oil or sesame oil.

3. A composition according to claim 1, wherein the liquid hydrocarbon is linear, branched or cyclic or a mixture thereof.

4. A composition according to claim 1, wherein the oil-soluble dye has an absorption maximum at about 700 nm.

5. A composition according to claim 1, wherein the C₁-C₄alkoxy-C₁-C₄alkanol is 2-methoxyethanol, 2-ethoxyethanol, 2-propoxyethanol, 2-butoxyethanol 2-methoxypropanol or 2-ethoxypropanol.

6. A composition according to claim 1, which comprises from 20 to 50% by weight of an unsaturated oil, from 30 to 70% by weight of a liquid hydrocarbon, from 5 to 35% by weight of a C₁-C₄alkoxy-C₁-C₄alkanol and from 0.01 to 0.05% by weight of an oil-soluble dye, based on the total weight of the composition.

7. A method of measuring the oil and grease-repellency of paper or paperboard, which comprises applying a composition which comprises an unsaturated oil, a liquid hydrocarbon, a C₁-C₄alkoxy-C₁-C₄alkanol and an oil-soluble dye to a sheet of paper or paperboard and measuring with a photoelectric cell the change in reflectance of the opposite side of the sheet as a function of time.

8. A method according to claim 7, wherein the change in reflectance of the opposite side of the sheet as a function of time is measured with a paper sizing tester comprising a photoelectric cell.

9. (canceled)

10. method according to claim 7, which comprises applying a composition which comprises from 20 to 50% by weight of an unsaturated oil, from 30 to 70% by weight of a liquid hydrocarbon, from 5 to 35% by weight of a C₁-C₄alkoxy-C₁-C₄alkanol and from 0.01 to 0.05% by weight of an oil-soluble dye, based on the total weight of the composition, to a sheet of paper or paperboard and measuring with a photoelectric cell the change in reflectance of the opposite side of the sheet as a function of time.
